(19) United States
(12) Patent Application Publication
(10) Pub. No.: US 2010/0277647 A1
(43) Pub. Date: Nov. 4, 2010

(54) NOISE DETECTION METHOD AND IMAGE PROCESSING METHOD USING THE NOISE DETECTION METHOD

(76) Inventor: Satoru Tanigawa, Hyogo (JP)

Correspondence Address: MCDERMOTT WILL & EMERY LLP, 600 13TH STREET, NW, WASHINGTON, DC, 20005-3096, US

(21) Appl. No.: 12/808,637

(22) PCT Filed: Jan. 29, 2009
(86) PCT No.: PCT/JP2009/000347

§ 371 Date: Jun. 16, 2010

(30) Foreign Application Priority Data
Mar. 24, 2008 (JP) 2008-076228

(51) Int. Cl. H04N 5/217; G06K 9/38

(52) U.S. Cl. 348/607; 382/270; 348/E05.078

(57) ABSTRACT

An image processing method includes a difference extraction step (103) of outputting a frame difference signal from an input image signal and from an image signal that has been frame-delayed so that a base value of noise of the film image is acquired from a portion of the film image of a 2-3 pull-down scheme where a signal that is identical every five fields, an integration step (107) of accumulating output signals of the difference extraction step, a detection step (106) that a difference of the entire frames is small based on the output signal of the difference extraction step, and an acquisition step (108) of acquiring, as a noise amount, an integrated value of the frame in the integrated step at timing when it is detected in the detection step that a difference of the entire frames is small. With this, noise is detected by the image processing method. A noise reduction step (113) is carried out using a result of the detection of noise.

### TECHNICAL FIELD

The present invention relates to a noise detection method for detecting noise from an input image signal and to an image processing method using the noise detection method, both used for reducing noise in the image signal and correcting a contour in a television receiver, a DVD player, a blue-ray player and the like.

### BACKGROUND ART

In recent years, in a television receiver using a liquid crystal display device or a plasma display device, as the screen becomes larger in size and resolution becomes higher, it becomes more important to display a higher quality image, and higher premium is put on a method of detecting an amount of noise included in an image, and on an image processing method of reducing a noise and correcting a contour in accordance with a state of an input image signal for enhancing noise reduction and contour correcting performance.

A film image signal formed in a 2-3 pull-down scheme is displayed frequently, and it is conceived that the film image signal is detected and an interlaced signal is converted into a non-interlaced signal. It is increasingly demanded to enhance the quality of a film image, and emphasis is placed on an image processing method corresponding to the film image.

According to a conventional image processing method in a television receiver, a set level of a film detection is controlled based on a noise amount of an input image signal, and when a noise level is high, the set level is relatively increased to detect a film image, and an interlaced signal is converted into a non-interlaced signal (see patent document 1).

### Citation List

### Patent Document

PATENT DOCUMENT 1: Japanese Patent Publication No. H11-341444

### SUMMARY OF THE INVENTION

### Technical Problem

According to the image processing method, however, although a film can be detected with a film image signal having high noise in the film detection, a noise level of the input film image is mixed with motion information and noise can not be detected correctly. Further, the noise level of a film image and a base noise component generated on a board on which an LSI is mounted or between connected devices can not be detected correctly. Further, noise can not be reduced in accordance with the base noise, and an amount of effect of the contour correction can not be changed.

The present invention has been accomplished in view of the above circumstances, and it is an object of the invention to provide a noise detection method having enhanced detection precision, and to enhance quality of an image processing result utilizing the noise detection method.

### Solution to the Problem

To solve the problem, according to the present invention, in a film image of 2-3 pull-down scheme, a base value of noise of the film image is acquired from a portion of the film image where a signal that is identical every five fields is sent, or from a portion of the film image where a complete still image is sent. In accordance with a result of detection obtained by the noise detection method of the invention having enhanced nose detection precision, noise of an input image signal is reduced, a degree of contrast of a contour portion is adjusted, and an image is processed in accordance with a noise amount, thereby enhancing the quality of an image.

### Advantages of the Invention

According to the invention, noise is detected from a portion of a film image of the 2-3 pull-down scheme where the identical image signal is sent. With this, only a noise level of the film image and a noise component generated on a board on which an LSI is mounted or between connected devices can correctly be detected. Since noise is detected at a portion where a still image is sent, it is possible to correctly detect a base noise component generated on the board on which the LSI is mounted or between the connected devices.

### BRIEF DESCRIPTION OF THE DRAWINGS

FIG. 1 is a block diagram showing a noise detection method and an image processing method using the noise detection method according to a first embodiment of the present invention;

FIG. 2 is a block diagram showing a noise detection method and an image processing method using the noise detection method according to a second embodiment of the invention;

FIG. 3 is a block diagram showing a noise detection method and an image processing method using the noise detection method according to a third embodiment of the invention;

FIG. 4 is a block diagram showing a noise detection method and an image processing method using the noise detection method according to a fourth embodiment of the invention;

FIG. 5 is a block diagram showing a noise detection method and an image processing method using the noise detection method according to a fifth embodiment of the invention;

FIG. 6 is a block diagram showing a noise detection method and an image processing method using the noise detection method according to a sixth embodiment of the invention;

FIG. 7 is a block diagram showing a noise detection method and an image processing method using the noise detection method according to a seventh embodiment of the invention; and

FIG. 8 is a block diagram showing a noise detection method and an image processing method using the noise detection method according to an eighth embodiment of the invention.

### DESCRIPTION OF EMBODIMENTS

Embodiments of the present invention will be described in detail based on the drawings.

### First Embodiment

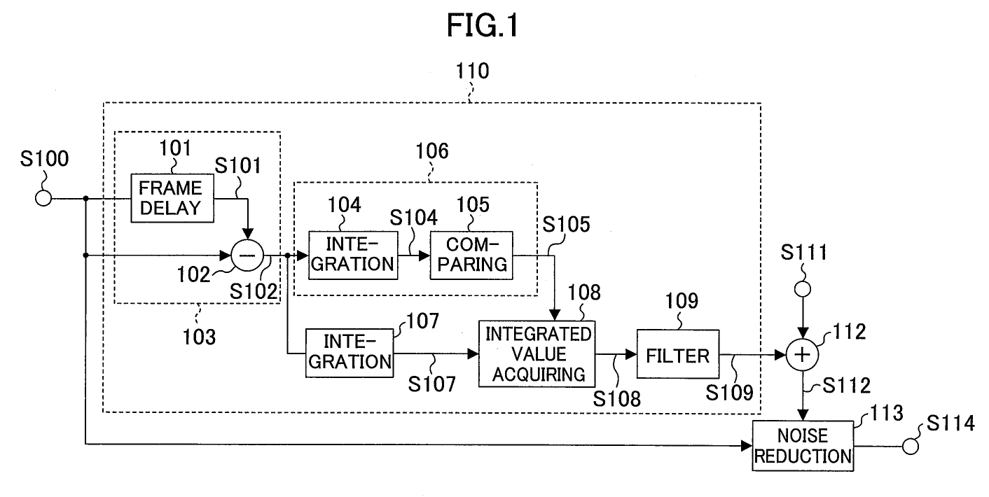

FIG. 1 is a block diagram showing a noise detection method and an image processing method using the noise detection method according to a first embodiment of the present invention. A reference number 101 represents a frame delay step for delaying a frame of an input image signal, a reference number 102 represents a difference step acquiring a difference between frames, and a reference number 103 including 101 and 102 represents a frame difference extraction step. A reference number 104 represents an integration step for accumulating output of the frame difference extraction step 103. A reference number 105 represents a comparing step for comparing the output of the integration step 104 with a threshold value. A reference number 106 including 104 and 105 represents a difference detection step of the entire frame for detecting a difference of the entire frame. A reference number 107 represents an integration step for accumulating output of the frame difference extraction step 103. A reference number 108 represents an integrated value acquiring step for acquiring an integrated value in accordance with output of the difference detection step 106 of the entire frame. A reference number 109 represents a filter step for restraining a result of an acquired integrated value from being abruptly changed. A reference number 110 including from 101 to 109 represents a noise detection step. A reference number 112 represents an adding step. A reference number 113 represents a noise reduction step.

An input image signal S100 is input to the frame delay step 101 to obtain a frame delay signal S101 that is delayed by one frame period. The frame delay signal S101 that has been delayed by one frame and the input image signal S100 are input to the difference step 102 to output a difference value S102 between the frames. The difference value S102 is input to the integration step 104 to accumulate difference values in one field period. The accumulated integrated value S104 is compared with a threshold value by the comparing step 105. When the integrated value S104 is greater than the threshold value, it is determined that a different image is input. When the integrated value S104 is smaller than the threshold value, it is determined that a same image is input. A comparison result S105 is output. When the film image of the 2-3 pull-down scheme is input and correctly determined, the same image is input to five fields once. Therefore, it is possible to detect that it is equal to or less than the threshold value once in the five fields. The difference value S102 is also input to the integration step 107 to accumulate difference values of one filed period. The integrated value acquiring step 108 acquires the integrated value S107 in accordance with the comparison result S105, and holds the integrated value S107 until the integrated value acquiring step 108 newly acquires the integrated value S107 next time. When the film image of the 2-3 pull-down scheme is input and correctly determined, the integrated value S107 is once acquired in the five fields, and the integration acquisition value S108 is renewed every five fields. The integration acquisition value S108 is input to the filter step 109, the integration acquisition value S108 is subjected to filtering processing such that the integration acquisition value S108 is not abruptly changed and the integration acquisition value S108 is smoothly changed, and it is output as the noise detection amount S109.

The noise detection amount S109 is synthesized with a preset noise reduction effect set value S111 by an adding step 112 to output a noise reduction effect amount S112.

The noise reduction step 113 reduces noise in accordance with the effect amount S112, and an image signal S114 whose noise has been reduced in accordance with a noise amount that is detected from fields having the same frame difference of the input image signal S100 is output.

Although the mutually independent two integration steps 104 and 107 have been explained above, one of them may be omitted and the other one may be used commonly.

### Second Embodiment

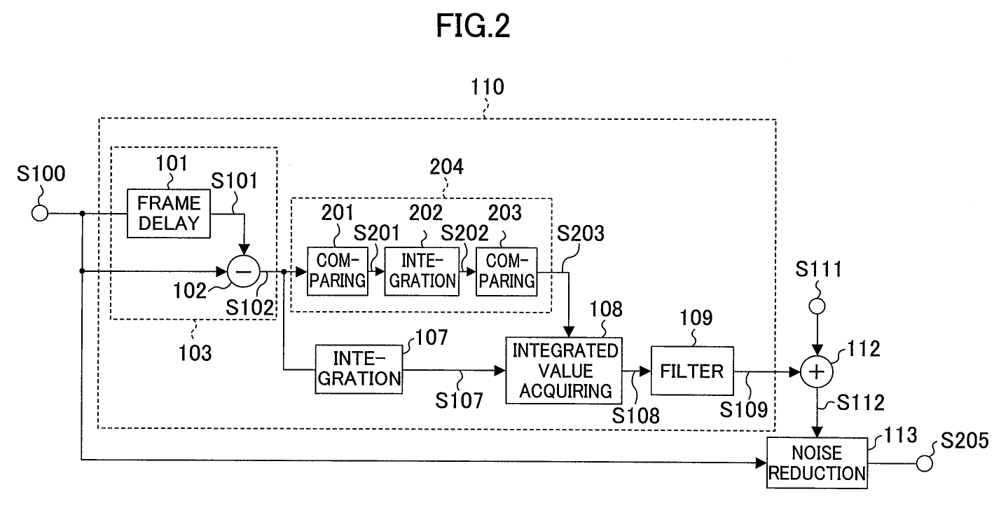

FIG. 2 is a block diagram showing a noise detection method and an image processing method using the noise detection method according to a second embodiment of the invention.

Contents that are explained in the previous embodiment are designated with the same reference numbers, explanation thereof is omitted, and only different portions will be explained intensively. A reference number 201 represents a comparing step for comparing output of the frame difference extraction step 103 with a threshold value. A reference number 202 represents an integration step for accumulating a comparison results between frames. A reference number 203 represents a comparing step for comparing an output of the integration step 202 with another threshold value. A reference number 204 including 201, 202 and 203 represents a difference detection step of the entire frames for detecting a difference of the entire frames.

According to the second embodiment, the difference detection step 106 of the entire frames in the first embodiment is replaced by the difference detection step 204 of the entire frames. The difference value S102 between the frames is input to the comparing step 201 to compare it with the threshold value, thereby determining whether there is a difference between the frames, and to compare the difference between the frames every picture element, thereby determining motion of every picture element. A determination result S201 is input to the integration step 202 to accumulate difference values in one field period. The accumulated integrated value S202 is compared with the threshold value by the comparing step 203. When the integrated value S202 is greater than the threshold value, it is determined as an image having much motion on a screen, and when the integrated value 5202 is smaller than the threshold value, it is determined as an image having small motion on the screen, and a comparison result S203 is output. When a difference on the screen is small, the integrated value acquiring step 108 acquires the integrated value S107. The noise reduction step 113 reduces noise in accordance with the effect amount S112, and an image signal S205 whose noise has been reduced in accordance with a noise amount that is detected from fields having small frame difference and having no motion or a small motion of the input image signal S100 is output.

### Third Embodiment

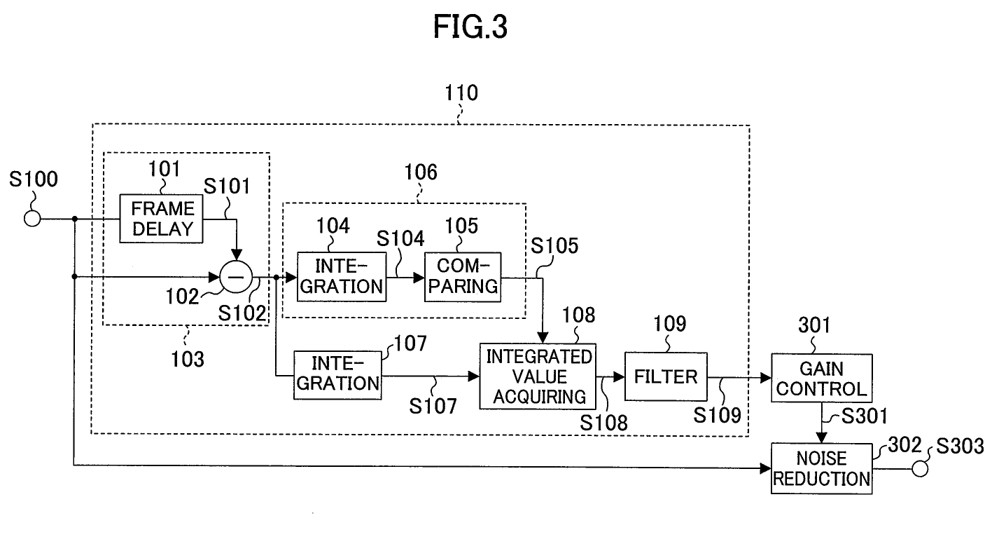

FIG. 3 is a block diagram showing a noise detection method and an image processing method using the noise detection method according to a third embodiment of the invention.

Contents that are explained in the previous embodiments are designated with the same reference numbers, explanation thereof is omitted, and only different portions will be explained intensively. A reference number 301 represents a gain control step, and a reference number 302 represents a noise reduction step.

According to the third embodiment, the noise detection amount S109 is input to the gain control step 301, and when the noise detection amount S109 is large, a gain is increased to enhance the effect of the noise reduction, and when the noise detection amount S109 is small, the gain is reduced to lower the effect of the noise reduction, and it is output as a gain amount S301 of the noise reduction. The noise reduction step 302 reduces noise in accordance with the gain amount S301, and an image signal S303 whose noise is reduced in accordance with a noise amount that is detected from fields having the same frame difference of the input image signal S100 is output.

The difference detection step 106 of the entire frames shown in FIG. 1 has been explained, but this may be replaced by the difference detection step 204 of the entire frames shown in FIG. 2.

### Fourth Embodiment

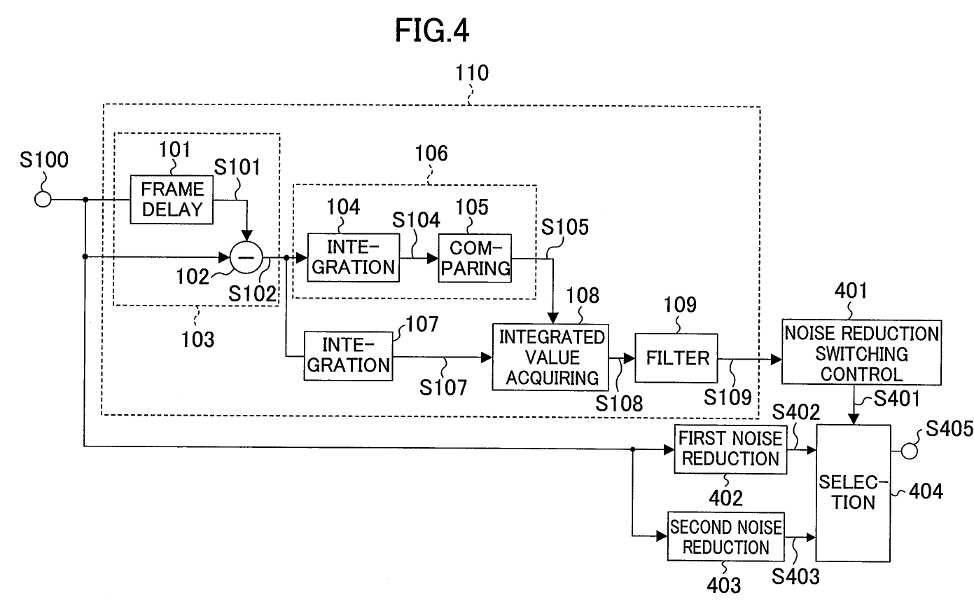

FIG. 4 is a block diagram showing a noise detection method and an image processing method using the noise detection method according to a fourth embodiment of the invention.

Contents that are explained in the previous embodiments are designated with the same reference numbers, explanation thereof is omitted, and only different portions will be explained intensively. A reference number 401 represents a noise reduction switching control step, a reference number 402 represents a first noise reduction step, a reference number 403 represents a second noise reduction step, and a reference number 404 represents a selection step.

In the fourth embodiment, there are the first noise reduction step 402 and the second noise reduction step 403, the noise detection amount S109 is input to the noise reduction switching control step 401, when the noise detection amount S109 is large, the selection step 404 selects output S402 of the first noise reduction step 402 in accordance with the switching control signal S401, and when the noise detection amount S109 is small, output S403 of the second noise reduction step 403 is selected. A step having high noise eliminating effect is prepared as the first noise reduction step 402, a step having low noise eliminating effect is prepared as the second noise reduction step 403, and an image signal S405 whose noise has been reduced in accordance with the noise detection amount S109 is output.

Although the first noise reduction step 402 and the second noise reduction step 403 are used in the above explanation, the input image signal S100 may be selected when noise is small without using the second noise reduction step 403.

Although the difference detection step 106 of the entire frames shown in FIG. 1 is explained, this may be replaced by the difference detection step 204 of the entire frames shown in FIG. 2.

### Fifth Embodiment

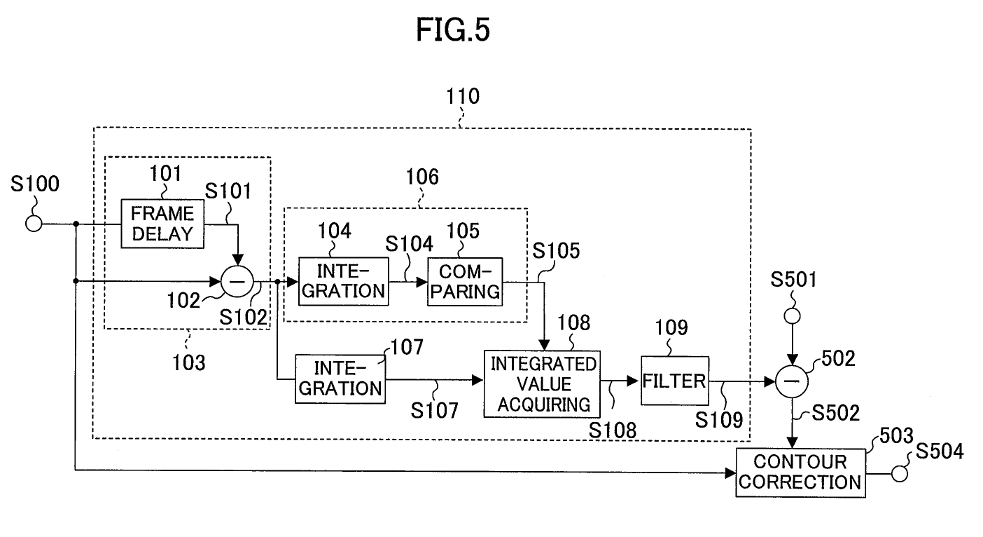

FIG. 5 is a block diagram showing a noise detection method and an image processing method using the noise detection method according to a fifth embodiment of the invention.

Contents that are explained in the previous embodiments are designated with the same reference numbers, explanation thereof is omitted, and only different portions will be explained intensively. A reference number 502 represents a subtraction step, and a reference number 503 represents a contour correction step.

According to the fifth embodiment, the noise detection amount S109 is synthesized with a preset contour correction effect set value S501 in the subtraction step 502, and is output as a contour correction effect amount S502. In the contour correction step 503, the contour is corrected in accordance with the effect amount S502, an image signal S504 whose contour has been corrected in accordance with a noise amount that is detected from fields having the same frame difference of the input image signal S100 is output.

Although the difference detection step 106 of the entire frames shown in FIG. 1 has been described, this may be replaced by the difference detection step 204 of the entire frames shown in FIG. 2.

### Sixth Embodiment

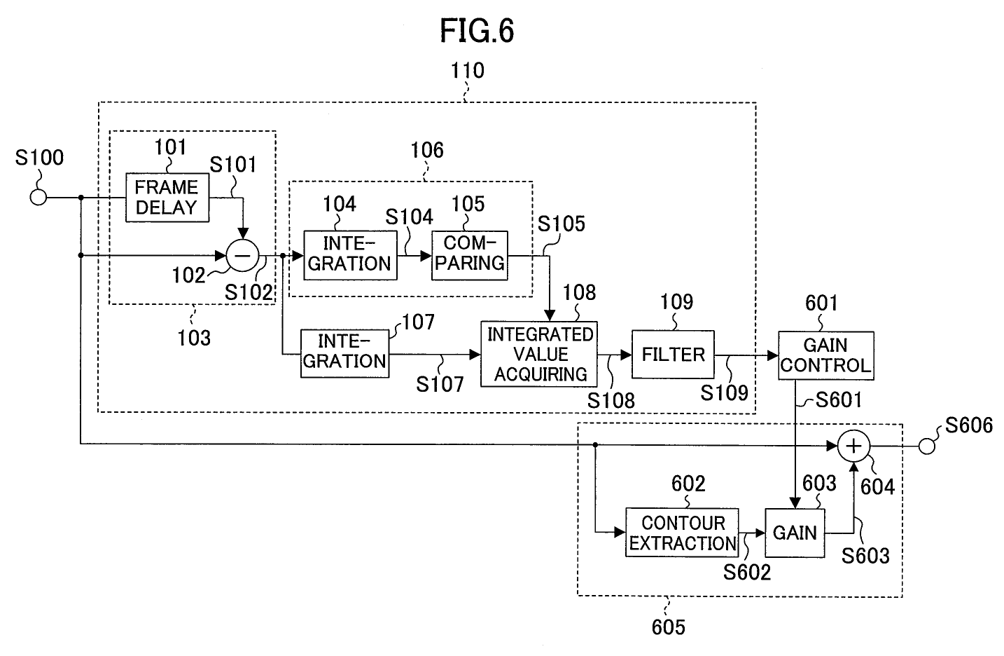

FIG. 6 is a block diagram showing a noise detection method and an image processing method using the noise detection method according to a sixth embodiment of the invention.

Contents that are explained in the previous embodiments are designated with the same reference numbers, explanation thereof is omitted, and only different portions will be explained intensively. A reference number 601 represents a gain control step, a reference number 602 represents a contour extraction step, a reference number 603 represents a contour correction gain adjusting step, a reference number 604 represents a synthesizing step for adding the contour correction amount to the input image signal, and a reference number 605 including 602, 603, and 604 represents a contour correction step.

According to the sixth embodiment, the noise detection amount S109 is input to the gain control step 601. When the noise detection amount S109 is large, the gain is reduced to lower the effect of the contour correction, and when the noise detection amount S109 is small, the gain is increased to enhance the effect of the contour correction, and it is output as the a gain amount S601 of contour correction. In the contour extraction step 602, contour correction component S602 of the input image signal S100 is extracted. The contour correction component S602 is input to a gain adjusting step 603, the gain is adjusted in accordance with the gain amount S601, a contour correction amount S603 is added to the input image signal S100 by the synthesizing step 604, and an image signal S606 whose contour has been corrected in accordance with a noise amount that is detected from fields having the same frame difference of the input image signal S100 is output.

Although the difference detection step 106 of the entire frames shown in FIG. 1 has been described, this may be replaced by the difference detection step 204 of the entire frames shown in FIG. 2.

### Seventh Embodiment

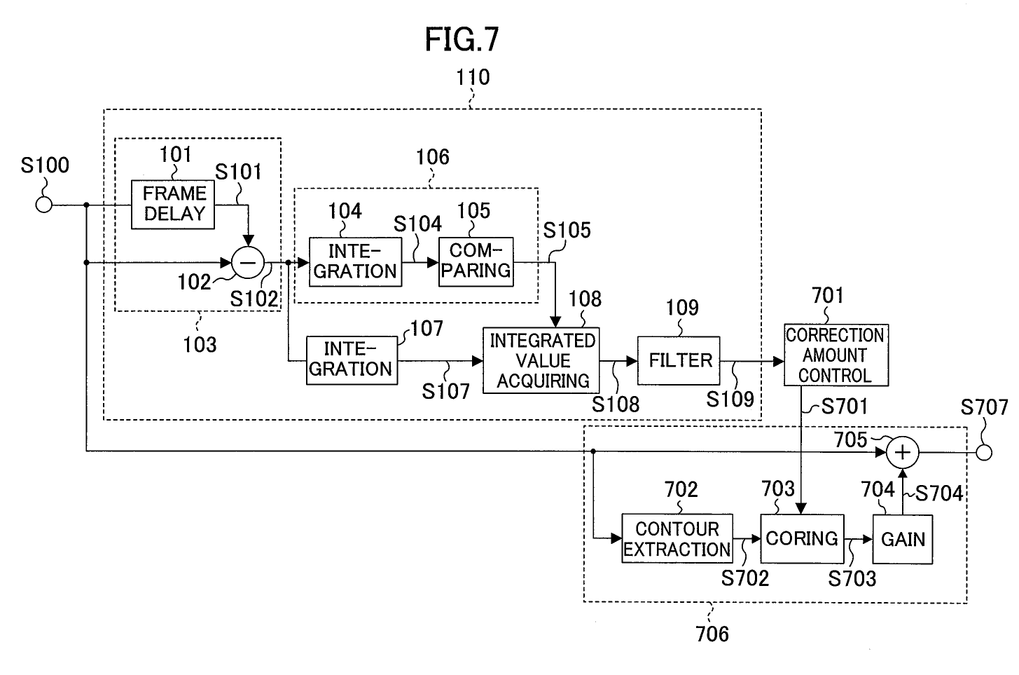

FIG. 7 is a block diagram showing a noise detection method and an image processing method using the noise detection method according to a seventh embodiment of the invention.

Contents that are explained in the previous embodiments are designated with the same reference numbers, explanation thereof is omitted, and only different portions will be explained intensively. A reference number 701 represents a correction amount control step, a reference number 702 represents a contour extraction step, a reference number 703 represents a coring step for removing a fine amplitude component, a reference number 704 represents a contour correction gain adjusting step, a reference number 705 represents a synthesizing step for adding the contour correction amount to the input image signal, and a reference number 706 including 702, 703, 704, and 705 represents a contour correction step.

According to the seventh embodiment, the noise detection amount S109 is input to the correction amount control step 701. When the noise detection amount S109 is large, a coring amount of the contour correction is increased, and when the noise detection amount S109 is small, the coring amount of contour correction is reduced, and it is output as the correction amount S701 of the contour correction. The contour extraction step 702 extracts a contour correction component S702 of the input image signal S100. The contour correction component S702 is input to the coring step 703, the coring amount is adjusted in accordance with the correction amount S701, when the coring amount is large, fine component in the contour-extracted correction component S702 is eliminated. A coring processing result S703 is input to the gain adjusting step 704, the synthesizing step 705 adds a contour correction amount S704 to the input image signal S100, and the image signal S707 whose contour has been corrected in accordance with a noise amount that is detected from fields having the same frame difference of the input image signal S100 is output.

Although the difference detection step 106 of the entire frames shown in FIG. 1 has been described, this may be replaced by the difference detection step 204 of the entire frames shown in FIG. 2.

### Eighth Embodiment

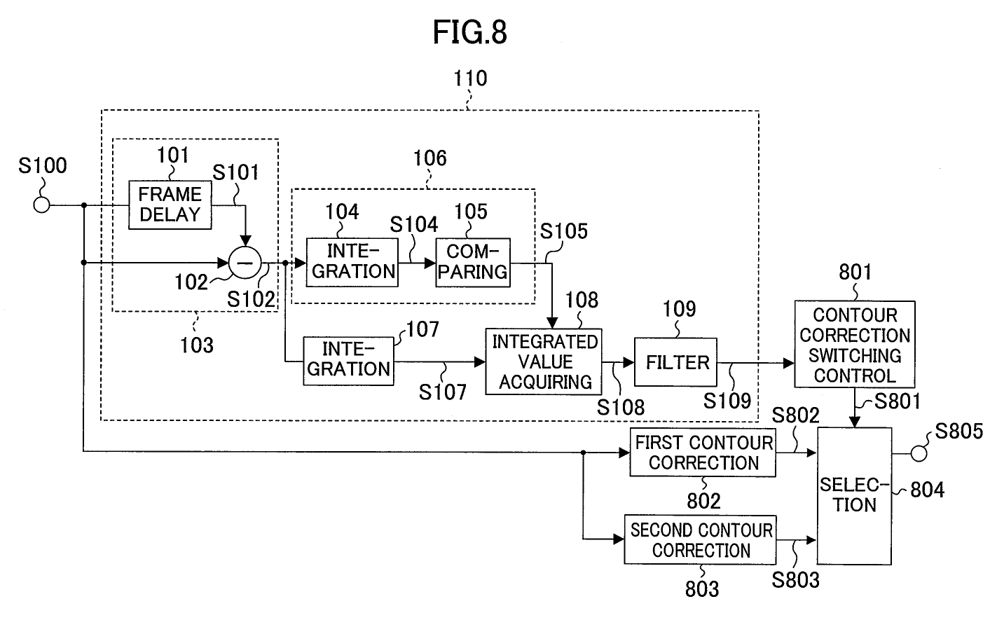

FIG. 8 is a block diagram showing a noise detection method and an image processing method using the noise detection method according to an eighth embodiment of the invention.

Contents that are explained in the previous embodiments are designated with the same reference numbers, explanation thereof is omitted, and only different portions will be explained intensively. A reference number 801 represents a contour correction switching control step, a reference number 802 represents a first contour correction step, a reference number 803 represents a second contour correction step, and a reference number 804 represents a selection step.

According to the eighth embodiment, there are the first contour correction step 802 and the second contour correction step 803, a noise detection amount S109 is input to the contour correction switching control step 801, when the noise detection amount S109 is small, an output S802 of the first contour correction step 802 is selected, and when the noise detection amount S109 is large, an output S803 of the second contour correction step 803 is selected in the selection step 804 in accordance with the switching control signal S801. A step having a high contour correction effect is prepared as the first contour correction step 802, and a step having a small contour correction effect is prepared as the second contour correction step 803, and an image signal S805 whose contour has been corrected in accordance with the noise detection amount S109 is output.

Although the first contour correction step 802 and the second contour correction step 803 are used in the above explanation, the second contour correction step 803 may not be used, and when noise is large, the input image signal S100 may be selected.

A contour correction that corrects low frequencies and high frequencies may be used as the first contour correction step 802, a contour correction that corrects only low frequencies may be used as the second contour correction step 803, and when there are much noise, high frequencies need not be corrected.

Although the difference detection step 106 of the entire frames shown in FIG. 1 has been explained, this may be replaced by the difference detection step 204 of the entire frames shown in FIG. 2.

The plurality of embodiments may be used, and the noise reduction step and the contour correction step may be carried out in order. Although it is described that the input image signal S100 is used as input of the noise reduction step and the contour correction step, output that has been non-interlace converted may be input.

### INDUSTRIAL APPLICABILITY

The noise detection method and the image processing method using the noise detection method are effective for processing an image signal such as noise reduction or contour correction in a playback apparatus such as a television receiver, a video cassette recorder and a DVD player.

### DESCRIPTION OF REFERENCE CHARACTERS

101 Frame Delay Step
102 Difference Step
103 Frame Difference Extraction Step
104 Integration Step
105 Comparing Step
106 Difference Detection Step of Entire Frames
107 Integration Step
108 Integrated Value Acquiring Step
109 Filter Step
110 Noise Detection Step
112 Adding Step
113 Noise Reduction Step
201 Comparing Step
202 Integration Step
203 Comparing Step
204 Difference Detection Step of Entire Frames
301 Gain Control Step
302 Noise Reduction Step
401 Noise Reduction Switching Control Step
402 First Noise Reduction Step
403 Second Noise Reduction Step
404 Selection Step
502 Subtraction Step
503 Contour Correction Step
601 Gain Control Step
602 Contour Extraction Step
603 Contour Correction Gain Adjusting Step
604 Synthesizing Step
605 Contour Correction Step
701 Correction Amount Control Step
702 Contour Extraction Step
703 Coring Step
704 Contour Correction Gain Adjusting Step
705 Synthesizing Step
706 Contour Correction Step
801 Contour Correction Switching Control Step
802 First Contour Correction Step
803 Second Contour Correction Step
804 Selection Step

1. An image processing method comprising:
a difference extraction step of outputting a frame difference signal from an input image signal and an image signal that has been frame-delayed;
an integration step of accumulating output signals of the difference extraction step;
a detection step of detecting that a difference of entire frames is small based on the output signal of the difference extraction step;
an acquisition step of acquiring an integrated value of a frame in the integration step as a noise amount at timing when it is detected in the detection step that a difference of the entire frames is small;
an adding step of adding the output signal in the acquisition step and an effect amount of preset noise reduction to each other; and
a step of reducing noise in accordance with an output of the adding step.

2. An image processing method comprising:
a difference extraction step of outputting a frame difference signal from an input image signal and an image signal that has been frame-delayed;
an integration step of accumulating output signals of the difference extraction step;
a detection step of detecting that a difference of entire frames is small based on the output signal of the difference extraction step;
an acquisition step of acquiring an integrated value of a frame in the integration step as a noise amount at timing when it is detected in the detection step that a difference of the entire frames is small;
an effect amount control step of controlling an effect amount of noise reduction from an output signal of the acquisition step; and
a step of reducing noise in accordance with an output of the effect amount control step.

3. An image processing method comprising:
a difference extraction step of outputting a frame difference signal from an input image signal and an image signal that has been frame-delayed;
an integration step of accumulating output signals of the difference extraction step;
a detection step of detecting that a difference of entire frames is small based on the output signal of the difference extraction step;
an acquisition step of acquiring an integrated value of a frame in the integration step as a noise amount at timing when it is detected in the detection step that a difference of the entire frames is small; and
a step of switching between first noise reduction and second noise reduction by an output signal of the acquisition step.

4. An image processing method comprising:
a difference extraction step of outputting a frame difference signal from an input image signal and an image signal that has been frame-delayed;
an integration step of accumulating output signals of the difference extraction step;
a detection step of detecting that a difference of entire frames is small based on the output signal of the difference extraction step;
an acquisition step of acquiring an integrated value of a frame in the integration step as a noise amount at timing when it is detected in the detection step that a difference of the entire frames is small; and
a step of selecting noise reduction when a noise amount is found to be large in accordance with an output signal of the acquisition step, and selecting an input signal when the noise amount is found to be small.

5. An image processing method comprising:
a difference extraction step of outputting a frame difference signal from an input image signal and an image signal that has been frame-delayed;
an integration step of accumulating output signals of the difference extraction step;
a detection step of detecting that a difference of entire frames is small based on the output signal of the difference extraction step;
an acquisition step of acquiring an integrated value of a frame in the integration step as a noise amount at timing when it is detected in the detection step that a difference of the entire frames is small;
a subtraction step of subtracting an output signal of the acquisition step and an effect amount of a preset contour correction; and
a step of correcting a contour in accordance with an output of the subtraction step.

6. An image processing method comprising:
a difference extraction step of outputting a frame difference signal from an input image signal and an image signal that has been frame-delayed;
an integration step of accumulating output signals of the difference extraction step;
a detection step of detecting that a difference of entire frames is small based on the output signal of the difference extraction step;
an acquisition step of acquiring an integrated value of a frame in the integration step as a noise amount at timing when it is detected in the detection step that a difference of the entire frames is small;
a contour gain control step of controlling a contour correction gain from an output signal of the acquisition step;
a contour gain step of controlling a gain of a contour correction value in which a contour portion is extracted from an input image signal in accordance with a value of the contour gain control step; and
an adding step of adding an output of the contour gain step to an input image signal.

7. An image processing method comprising:
a difference extraction step of outputting a frame difference signal from an input image signal and an image signal that has been frame-delayed;
an integration step of accumulating output signals of the difference extraction step;
a detection step of detecting that a difference of entire frames is small based on the output signal of the difference extraction step;
an acquisition step of acquiring an integrated value of a frame in the integration step as a noise amount at timing when it is detected in the detection step that a difference of the entire frames is small;
a coring amount control step of controlling a coring amount for removing a fine signal component of a contour extraction signal from an output signal of the acquisition step;
a coring step of controlling the coring amount for removing the fine signal component of a contour correction value in which a contour portion is extracted from an input image signal in accordance with a value of the coring amount control step; and
an adding step of multiplying an output of the coring step by a set gain and then, adding the same to the input image signal.

8. An image processing method comprising:
a difference extraction step of outputting a frame difference signal from an input image signal and an image signal that has been frame-delayed;
an integration step of accumulating output signals of the difference extraction step;
a detection step of detecting that a difference of entire frames is small based on the output signal of the difference extraction step;
an acquisition step of acquiring an integrated value of a frame in the integration step as a noise amount at timing when it is detected in the detection step that a difference of the entire frames is small; and
a step of switching between a first contour correction step and a second contour correction step by an output signal of the acquisition step.

9. An image processing method comprising:
a difference extraction step of outputting a frame difference signal from an input image signal and an image signal that has been frame-delayed;
an integration step of accumulating output signals of the difference extraction step;
a detection step of detecting that a difference of entire frames is small based on the output signal of the difference extraction step;
an acquisition step of acquiring an integrated value of a frame in the integration step as a noise amount at timing when it is detected in the detection step that a difference of the entire frames is small; and
a step of selecting an input signal when a noise amount is found to be large in accordance with an output signal of the acquisition step, and selecting a contour correction step when the noise amount is found to be small.

10. A noise detection method comprising:
a difference extraction step of outputting a frame difference signal from an input image signal and an image signal that has been frame-delayed;
an integration step of accumulating output signals of the difference extraction step;
a detection step of detecting that a difference of entire frames is small based on the output signal of the difference extraction step; and
an acquisition step of acquiring an integrated value of a frame in the integration step as a noise amount at timing when it is detected in the detection step that a difference of the entire frames is small.

11. The noise detection method of claim 10, wherein
in the detection step of detecting that the difference of the entire frames is small, a comparing step of comparing an output value of the integration step and a threshold value with each other is used, a 2-3 pull-down scheme of a film image input is detected by comparing the threshold value in size, and
an integrated value of a difference value between frames smaller than the threshold value is acquired in the acquisition step.

12. The noise detection method of claim 10, wherein
the detection step of detecting that the difference of the entire frames is small includes an integration step of detecting motion by comparing the threshold value in size using a comparing step of comparing a difference value of the difference extraction step and the threshold value with each other, results of detection of motion are accumulated in each of frames, and
in the acquisition step, an integrated value of the frames is acquired when there is no motion of the entire frames or when motion of the entire frame is smaller than a threshold value.
